(19) United States
(12) Patent Application Publication
(10) Pub. No.: US 2018/0171123 A1
(43) Pub. Date: Jun. 21, 2018

(54) RUBBER COMPOSITION

(71) Applicant: TOYO TIRE & RUBBER CO., LTD., Itami-shi (JP)

(72) Inventor: Yuma Nishikawa, Itami-shi (JP)

(73) Assignee: TOYO TIRE & RUBBER CO., LTD., Itami-shi (JP)

(21) Appl. No.: 15/801,530

(22) Filed: Nov. 2, 2017

(30) Foreign Application Priority Data
Dec. 21, 2016 (JP) 2016-247995

(51) Int. Cl. C08L 9/06; C08L 7/00; C08L 71/02; C08K 3/36

(52) U.S. Cl. CPC C08L 9/06; C08K 3/36; C08L 71/02; C08L 7/00

(57) ABSTRACT

A rubber composition, comprising a rubber component which includes a diene rubber, a filler, and a powdery rubber, and further comprising an aromatic polyoxyethylene derivative. When the entire amount of the rubber component is regarded as 100 parts by mass, the aromatic polyoxyethylene derivative is preferably included in an amount of 0.1 to 10 parts by mass.

### BACKGROUND OF THE INVENTION

### Field of the Invention

The present invention relates to a rubber composition including a rubber component which includes a diene rubber, a filler, and a powdery rubber.

### Description of the Related Art

Rubber product wastes, such as waste tires, have been conventionally reused, and have been reused, for example, as fuels in cement factories and others. In recent years, under the consideration of environmental problems, material recycle is recommended, in which waste tires and the like are pulverized and the resultant is used, as it is, as rubber pieces or powdery rubber. However, there has been caused a problem that when powdery rubber obtained by pulverizing waste tires and the like into fine powder is blended into a new rubber, the resultant rubber composition rises in viscosity to be deteriorated in workability, or that a vulcanized rubber yielded by vulcanizing the rubber composition is deteriorated in physical properties, for example, abrasion resistance and tearing force.

In order to provide a rubber composition which keeps a good workability although a powdery rubber is blended into the rubber composition, Patent Document 1 listed below reports a technique of blending a glycerine fatty-acid ester composition into a rubber composition.

In order to provide a finely-particulate-rubber-containing rubber composition which keeps a high fracture property and abrasion resistance and which can improve the resultant rubber product wastes in recyclability, Patent Document 2 listed below reports a technique of adding, into a rubber composition, a processing aid formed of a fatty acid ester, a fatty acid metal salt, or a mixture of a fatty acid ester and a fatty acid metal salt.

In order to provide a rubber composition which has abrasion resistance and low exothermicity and gives a high recycling rate, Patent Document 3 listed below reports a technique of adding, into a rubber composition, a compound having a moiety Q which contains a dipolar nitrogen, and a 4-6 nitrogen-containing heterocyclic moiety B which contains oxygen or sulfur.

In order to provide a regenerated-rubber-including rubber composition which can be restrained from being lowered in fracture property, abrasion resistance, exothermic property and other properties and which can improve the resultant tire or other rubber products in recyclability after the use of the tire or the products, Patent Document 4 listed below reports a technique of using, in a rubber composition, an oil-extended rubber in a proportion of 20% or more by weight of the composition provided that this rubber includes a conjugated diene copolymer rubber and an extender oil at a ratio by weight of 100:0 to 100:80.

### PRIOR ART DOCUMENTS

### Patent Documents

Patent Document 1: JP-A-2016-10842

Patent Document 2: JP-A-2009-35603

Patent Document 3: JP-A-2007-224072

Patent Document 4: JP-A-2003-253046

However, according to the techniques described in the Patent Documents, it is difficult that while a powdery rubber-containing rubber composition is improved in workability, a vulcanized rubber obtained from this composition is improved in rubber properties such as abrasion resistance and tearing force.

### SUMMARY OF THE INVENTION

In the light of the above-mentioned actual situation, the present invention has been made, and an object thereof is to provide a rubber composition which includes a powdery rubber but is excellent in workability, and further which can be a raw material for a vulcanized rubber excellent in abrasion resistance and tearing force.

The object can be attained by the present invention, which is the following: a rubber composition including a rubber component which includes a diene rubber, a filler, and a powdery rubber, and further including an aromatic polyoxyethylene derivative.

When a powdery rubber yielded by pulverizing a waste tire or the like is blended into a rubber composition, the rubber composition usually tends to be deteriorated in workability. However, the rubber composition according to the present invention includes the aromatic polyoxyethylene derivative; thus, the rubber composition is improved in workability, and additionally the resultant vulcanized rubber is also improved in rubber properties, particularly, abrasion resistance and tearing force. It can be presumed that reasons why these advantageous effects can be gained are as follows.

(i) A polyoxyethylene moiety which the aromatic polyoxyethylene derivative has exhibits a polymer lubrication effect for the rubber component and the powdery rubber in the rubber composition. Thus, when the rubber composition is worked, the moiety produces an effect of decreasing the viscosity of the rubber composition. In this way, the rubber composition is improved in workability.

(ii) When the rubber composition includes, as the filler, for example, carbon black, an aromatic ring moiety which the aromatic polyoxyethylene derivative has shows an intense interaction with carbon black contained in the powdery rubber and carbon black contained in the rubber component. When the rubber composition includes, as the filler, silica, the polyoxyethylene moiety, which the aromatic polyoxyethylene derivative has, shows an intense interaction with silica contained in the rubber component. As a result of these interactions, a vulcanized rubber of the rubber composition according to the present invention is improved in rubber properties, particularly, abrasion resistance and tearing force.

When the entire amount of the rubber component is regarded as 100 parts by mass in the rubber composition, the aromatic polyoxyethylene derivative is included preferably in an amount of 0.1 to 10 parts by mass.

When the entire amount of the rubber component is regarded as 100 parts by mass in the rubber composition, the powdery rubber is included preferably in an amount of 0.1 to 40 parts by mass.

### DETAILED DESCRIPTION OF THE PREFERRED EMBODIMENTS

The rubber composition according to the present invention includes a rubber component which includes a diene rubber, a filler, and a powdery rubber, and further includes an aromatic polyoxyethylene derivative.

Examples of the diene rubber include natural rubber (NR); synthetic diene rubbers such as isoprene rubber (IR), butadiene rubber (BR), styrene butadiene rubber (SBR), butyl rubber (IIR), and acrylonitrile butadiene rubber (NBR); halogenated butyl rubbers such as brominated butyl rubber (BR-IIR); other synthetic rubbers such as polyurethane rubber, acrylic rubber, fluorine-contained rubber, silicone rubber, and chlorosulfonated polyethylene. It is preferred in the present invention to use, out of these examples, at least one kind of natural rubber, styrene butadiene rubber and butadiene rubber.

In the present invention, the filler means an inorganic filler used ordinarily in the rubber industry, such as carbon black, silica, clay, talc, calcium carbonate, magnesium carbonate, or aluminum hydroxide. In the present invention, out of these inorganic fillers, carbon black or silica are in particular preferably usable. Alternatively, a combination of carbon black with silica is also usable.

The species of the carbon black may be any carbon black species used in an ordinary rubber industry, such as SAF, ISAF, HAF, FEF or GPF, or may be an electro-conductive carbon black species such as acetylene black or ketjen black. The form of the carbon black species may be a granulated carbon black species, which has been granulated, considering the handleability thereof in an ordinary rubber industry; or may be a non-granulated carbon black species.

The species of the silica may be a species usable for ordinary rubber-reinforcement, such as wet silica, dry silica, sol-gel silica or surface-treated silica. Out of these species, wet silica is preferred. When the silica is used, it is preferred to use a silane coupling agent together. The silane coupling agent is not particularly limited as far as the agent is a silane coupling agent containing, in the molecule thereof, sulfur. In the rubber composition, various silane coupling agents are usable which are each blended together with silica. Examples thereof include sulfide silanes such as bis(3-triethoxysilylpropyl) tetrasulfide (for example, “Si 69” manufactured by Degussa AG), bis(3-triethoxysilylpropyl) disulfide (for example, “Si 75” manufactured by Degussa AG), bis(2-triethoxysilylethyl) tetrasulfide, bis(4-triethoxysilylbutyl) disulfide, bis(3-trimethoxysilylpropyl) tetrasulfide, and bis(2-trimethoxysilylethyl) disulfide; mercaptosilanes such as γ-mercaptopropyltrimethoxysilane, γ-mercaptopropyltriethoxysilane, mercaptopropylmethyldimethoxysilane, mercaptopropyldimethylmethoxysilane, and mercaptoethyltriethoxysilane; and protected mercaptosilanes such as 3-octanoylthio-1-propyltriethoxysilane, and 3-propionylthiopropyltrimethoxysilane. The blend amount of the silane coupling agent is preferably from 5 to 15 parts by mass, more preferably from 5 to 10 parts by mass for 100 parts by mass of the silica.

In the present invention, the blend amount of the filler in the rubber composition is preferably from 20 to 120 parts by mass, more preferably from 30 to 80 parts by mass for 100 parts by mass of the diene rubber.

The powdery rubber is preferably a partially vulcanized powdery rubber. In the case of considering, particularly, environmental problems, the powdery rubber is preferably a powdery rubber yielded by pulverizing, into powder, a regenerated rubber obtained by use of used tires as raw material. In the case of considering the abrasion resistance and the tearing force of the resultant vulcanized rubber, and the workability of the rubber composition, the particle size of the powdery rubber is preferably 80 mesh or more, more preferably 140 mesh or more, the words “mesh” herein being according to ASTM D5644-01.

In the present invention, the blend amount of the powdery rubber in the rubber composition is preferably from 0.1 to 40 parts by mass, more preferably from 5 to 30 parts by mass for 100 parts by mass of the rubber component.

The aromatic polyoxyethylene derivative is composed of an aromatic ring moiety such as benzene, naphthalene, and anthracene, and a polyoxyethylene moiety. In the polyoxyethylene moiety, the number of polymerized oxyethylene units is, for example, preferably from about 1 to 20. The aromatic polyoxyethylene derivative is in particular preferably a compound represented by each of the following general formulae.

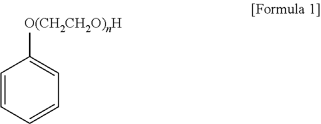

wherein n is an integer from 1 to 20.

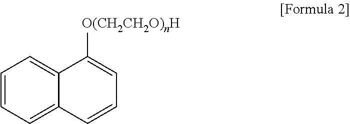

wherein n is an integer from 1 to 20.

In the present invention, the blend amount of the aromatic polyoxyethylene derivative in the rubber composition is preferably from 0.1 to 10 parts by mass, more preferably from 0.5 to 7 parts by mass for 100 parts by mass of the diene rubber.

In addition to the diene-rubber-including rubber component, filler, powdery rubber and aromatic polyoxyethylene derivative each detailed above, blending agents used ordinarily in the rubber industry may be appropriately blended into the rubber composition of the present invention as far as the advantageous effects of the present invention are not impaired. Examples of the blending agents include a sulfur-containing vulcanizing agent, a vulcanization accelerator, a silane coupling agent, stearic acid, a vulcanization accelerator aid, a vulcanization retardant, an antiaging agent, softeners such as wax and oil, and a processing aid.

The vulcanization accelerator may be a vulcanization accelerator used ordinarily for rubber-vulcanization. Examples thereof include sulfonamide type, thiuram type, thiazole type, thiourea type, guanidine type, and dithiocarbamate type vulcanization accelerators. Such vulcanization accelerators may be used singly or in the form of an appropriate mixture of two or more thereof.

The antiaging agent may be an antiaging agent used ordinarily for rubbers, examples thereof including aromatic amine type, amine-ketone type, monophenolic type, bisphenolic type, polyphenolic type, dithiocarbamate type, and thiourea type antiaging agents. Such antiaging agents may be used singly or in the form of an appropriate mixture of two or more thereof.

The rubber composition of the present invention can be yielded by using a kneading machine used in an ordinary rubber industry, such as a Banbury mixer, a kneader or a roll, to mix/knead the diene-rubber-including rubber component, filler, powdery rubber, and aromatic polyoxyethylene derivative each detailed above, and components that may be optionally used, which are a sulfur-containing vulcanizing agent, a vulcanization accelerator, a silane coupling agent, stearic acid, a vulcanization accelerator aid, a vulcanization retardant, an antiaging agent, softeners such as was and oil, a processing aid and others.

The method for blending each component with each other is not particularly limited, and may be, for example, a method of mixing/kneading, in advance, blending components other than the vulcanization component such as sulfur-containing vulcanizing agent and the vulcanization accelerator to prepare a masterbatch, adding the remaining components thereto, and further mixing/kneading the entire components; a method of adding, each components in any order, and then mixing/kneading the components; or a method of adding the entire components simultaneously and mixing/kneading the components.

### EXAMPLES

Hereinafter, the present invention will be more specifically described by demonstrating examples thereof.

### Preparation of Each Rubber Composition

In a blend formulation in one of Tables 1 and 2, each raw material in each of Examples 1 to 6 and Comparative Examples 1 to 4 was blended into 100 parts by mass of a diene rubber, and then the resultant blend was kneaded by using an ordinary Banbury mixer to prepare a rubber composition. The used raw materials shown in Tables 1 and 2 are described below.

### Used Raw Materials

a) Diene rubbers
NR: “RSS#3”
S-SBR (solution-polymerized SBR): “HPR 350”, manufactured by JSR Corporation
BR: “BR 150B”, manufactured by Ube Industries, Ltd.

b) Fillers:
Silica: “NIPSIL AQ” manufactured by Tosoh Silica Corporation

Carbon black: “DIABLACK N341” manufactured by Mitsubishi Chemical Corporation

c) Powdery rubber: “PD 140 BU” manufactured by Lehigh Technologies

d) Aromatic polyoxyethylene derivatives:
Polyoxyethylene naphthyl ether: “NOIGEN EN” manufactured by DKS Co., Ltd.
Polyoxyethylene phenyl ether: “PHE-1” manufactured by DKS Co., Ltd.

e) Silane coupling agent: “Si 75” manufactured by Evonik Degussa GmbH

f) Oil: “EXTRACT No. 4, S” manufactured by Showa Shell Sekiyu K.K.

g) Zinc flower: “Zinc flower No. 1” manufactured by Mitsui Mining & Smelting Co., Ltd.

Antiaging agent: “NOCRAC 6C” manufactured by Ouchi Shinko Chemical Industrial Co., Ltd.

i) Stearic acid: “LUNAC S20” manufactured by Kao Corporation

j) Sulfur: “POWDERY SULFUR” manufactured by Tsurumi Chemical Industry Co., Ltd.

k) Vulcanization accelerators:
Vulcanization accelerator 1: “NOCCELER D”, manufactured by Ouchi Shinko Chemical Industrial Co., Ltd.

Vulcanization accelerator 2: “SOXINOL CZ” manufactured by Sumitomo Chemical Co., Ltd.

### Evaluating Items

### (1) Workability

In accordance with JIS K6300, a rotor-less Mooney measuring instrument manufactured by Toyo Seiki Seisaku-sho, Ltd. was used to heat the unvulcanized rubber of each of the above-mentioned examples at 100° C. for 1 minute by remaining heat, and measure, after 4 minutes, the torque value thereof in the unit of Mooney. About each of Examples 1 and 2, and Comparative Example 2, the measured value was represented as an index relative to the value of Comparative Example 1, this value being regarded as 100. About each of Examples 3 to 6, and Comparative Example 4, the measured value was represented as an index relative to the value of Comparative Example 2, this value being regarded as 100. It is meant that as the resultant numerical value is smaller, the rubber composition is better in workability.

### (2) Abrasion Resistance

A Lambourn abrasion tester manufactured by Iwamoto Seisaku-sho Co., Ltd. was used to measure the abrasion loss of a sample of each of the above-mentioned examples at a load of 40 N, and a slip ratio of 30% in accordance with JIS K6264. About each of Examples 1 and 2, and Comparative Example 2, the measured value was represented as an index relative to the value of Comparative Example 1, this value being regarded as 100. About each of Examples 3 to 6, and Comparative Example 4, the measured value was represented as an index relative to the value of Comparative Example 2, this value being regarded as 100. It is meant that as the resultant numerical value is larger, the vulcanized rubber is better in abrasion resistance.

### (3) Tearing Force

A crescent shaped member prescribed in JIS K6252 was used to punch out a sample of each of the examples. In the center of a dent in the punched-out sample, a notch of 0.50±0.08 mm in size was made. A test of the resultant was made through a tensile tester manufactured by Shimadzu Corporation at a tension rate of 500 mm/min. About each of Examples 1 and 2, and Comparative Example 2, the measured value was represented as an index relative to the value of Comparative Example 1, this value being regarded as 100. About each of Examples 3 to 6, and Comparative Example 4, the measured value was represented as an index relative to the value of Comparative Example 2, this value being regarded as 100. It is meant that as the resultant numerical value is larger, the vulcanized rubber is better in tearing force.

TABLE 1

| | Compar- | Compar- | | | |
|---|---|---|---|---|---|
| | ative | ative | Exam- | Exam- | Exam- |
| | Example 1 | Example 2 | ple 1 | ple 2 | ple 3 |
| NR | 80 | 80 | 80 | 80 | 80 |
| BR | 20 | 20 | 20 | 20 | 20 |
| Carbon black | 60 | 60 | 60 | 60 | 60 |
| Powdery rubber | | 20 | 20 | 20 | 30 |
| Oil | 10 | 10 | 10 | 10 | 10 |
| Zinc flower | 3 | 3 | 3 | 3 | 3 |
| Antiaging agent | 2 | 2 | 2 | 2 | 2 |
| Stearic acid | 2 | 2 | 2 | 2 | 2 |
| Polyoxyethylene | | | 3 | | |
| naphthyl ether | | | | | |
| Polyoxyethylene | | | | 3 | 3 |
| phenyl ether | | | | | |
| Sulfur | 1.5 | 1.5 | 1.5 | 1.5 | 1.5 |
| Vulcanization | 1.5 | 1.5 | 1.5 | 1.5 | 1.5 |
| accelerator 1 | | | | | |
| Workability | 100 | 110 | 90 | 92 | 95 |
| Abrasion resistance | 100 | 90 | 110 | 110 | 107 |
| Tearing force | 100 | 97 | 112 | 109 | 108 |

TABLE 2

| | Comparative | Comparative | | | | | |
|---|---|---|---|---|---|---|---|
| | Example 1 | Example 2 | Example 1 | Example 2 | Example 3 | Example 4 | Example 5 |
| NR | 20 | 20 | 20 | 20 | 20 | 20 | 20 |
| S-SBR | 80 | 80 | 80 | 80 | 80 | 80 | 80 |
| Carbon black | 10 | 10 | | | | | |
| Silica | 50 | 50 | 60 | 60 | 60 | 60 | 60 |
| Silane coupling agent | 5 | 5 | 5 | 5 | 5 | 5 | 5 |
| Powdery rubber | | 20 | 20 | 20 | 20 | 20 | 35 |
| Oil | 20 | 20 | 20 | 20 | 20 | 20 | 20 |
| Zinc flower | 3 | 3 | 3 | 3 | 3 | 3 | 3 |
| Antiaging agent | 2 | 2 | 2 | 2 | 2 | 2 | 2 |
| Stearic acid | 2 | 2 | 2 | 2 | 2 | 2 | 2 |
| Polyoxyethylene | | | 1 | 3 | 6 | | |
| naphthyl ether | | | | | | | |
| Polyoxyethylene | | | | | | 3 | 3 |
| phenyl ether | | | | | | | |
| Sulfur | 2 | 2 | 2 | 2 | 2 | 2 | 2 |
| Vulcanization | 1.5 | 1.5 | 1.5 | 1.5 | 1.5 | 1.5 | 1.5 |
| accelerator 1 | | | | | | | |
| Vulcanization | 1.5 | 1.5 | 1.5 | 1.5 | 1.5 | 1.5 | 1.5 |
| accelerator 2 | | | | | | | |
| Workability | 100 | 114 | 98 | 95 | 90 | 96 | 99 |
| Abrasion resistance | 100 | 92 | 102 | 105 | 106 | 103 | 102 |
| Tearing force | 100 | 95 | 112 | 112 | 115 | 110 | 105 |

What is claimed is:

1. A rubber composition, comprising a rubber component which includes a diene rubber, a filler, and a powdery rubber, and further comprising an aromatic polyoxyethylene derivative.

2. The rubber composition according to claim 1, wherein when the entire amount of the rubber component is regarded as 100 parts by mass, the aromatic polyoxyethylene derivative is included in an amount of 0.1 to 10 parts by mass.

3. The rubber composition according to claim 1, wherein when the entire amount of the rubber component is regarded as 100 parts by mass, the powdery rubber is included in an amount of 0.1 to 40 parts by mass.
